(19) United States
(12) Patent Application Publication
(10) Pub. No.: US 2005/0210370 A1
(43) Pub. Date: Sep. 22, 2005

(54) Constant range of size character data entry and error indication system

(76) Inventor: Danny Mark Sandler, Brooklyn, NY (US)

Correspondence Address: Danny Sandler, PO Box 351110, Brooklyn, NY, 11235, US

(21) Appl. No.: 10/959,688

(22) Filed: Oct. 6, 2004

Related U.S. Application Data
(60) Provisional application No. 60/510,291, filed on Oct. 9, 2003.

(51) Int. Cl. G06F 17/00; G06F 3/00

(52) U.S. Cl. 715/507; 715/862; 715/505; 345/168; 434/167

(57) ABSTRACT

A constant range of size data entry system that contains several methods for; an ease of use keyboard interface and; methods that automatically indicate(s) individual data and or character error(s) when compared to predefined data and or a character set. This allows the end user to enter data into a system that will compare the individual characters with a predetermined set and or array of characters. And will show the end user an interactive change in media based upon the values entered. The media change will show which characters do not match and or match up to the predetermined characters set. The program relies on a different data entry system then an ordinary word processor. So instead of buffering or expanding as one types and shrinking as one deletes, the program traverses over a set of predetermined data entry point and or text input fields with exclusive methods in place that simulate standard word processing.

### CROSS REFERENCE TO RELATED APPLICATIONS

This application claims benefit of provisional patent application No. 60/510,291 filed Oct. 9, 2003.

### FIELD OF INVENTION

This invention is a combination of interconnected methods which function as a system for entering characters into individual predefined text-input fields and allowing the user to submit the characters in order to compare the characters with a predefined constant array of character(s). Once compared, each character that is in error will be indicated by its own interactive change in media. Further, methods are in place that will cause an interactive change in media; based on three Boolean values (Mistakes, No Mistakes, No Empty Text-input fields).

### BACKGROUND OF THE AND SUMMERY OF INVENTION

It all started back in October of 2002 when I was coming up with concepts that could be sold into the worldwide e-learning industry. I thought back to my childhood days as a student in the public education system. The spelling primer . . . which is a paperback book that contained words with some of the letters missing. In the missing letters' place are white squares. The student's task is to write the appropriate letters in the white squares in relationship to the partial word. The teacher would grade the task by putting Xs through any incorrect letters that he or she found.

This invention is important because currently there are many software systems on the market today that show misspelled words. But, this invention goes a step further by showing the actual individual letter(s) that have been misspelled, not just the word. It is well known that students learn spelling by understanding incorrect and correct sets of letters. Spelling and or language is better understood through visual linguistics (patterns of character or letter placement).
Durrell, D. D. (1980). “Commentary: Letter name values in reading and spelling.” Reading Research Quarterly, 16, 159-163.
Ehri, L. (1983). A critique of five studies related to letter-name knowledge and learning to read. In L. M. Gentile, M. L. Kamil, & J. S. Blanchard (Eds.), Reading revisited. Columbus, Ohio: Charles Merrill.

Currently, there is no computer software that effectively instructs with patterns of letter placement. Rather, current technology shows a simplistic Boolean evaluation. The word is either correct or incorrect. It does not show the student which letter(s) were incorrect . . . . just the word itself.

So I developed a concept and an algorithm-design to automate and expand upon the above-mentioned manual process.

This invention automatically indicates individual character errors in relation to a predetermined character set. You could say a spelling error indicator system, but it is definitely not limited to just that concept.

Since the principal market for this invention is in the elementary and secondary education market, an ease of use system of processing the characters into the text-input fields needed to be developed. I did not want the students to be distracted from their studies at hand by annoying and unpractical methods of data entry. So I designed a system that can be typed directly into upon the loading of a set of text fields without any additional mouse clicking or other formatting measures. When the Text field loads the cursor is automatically focused to the appropriate text field for the given lesson. Students also, in many cases, make mistakes that they can identify, themselves, before they submit their response for automated processing. So methods were developed such as event responses to the backspace, space, right arrow and left arrow keys. All were designed with methods that were designed to make it similar to normal keyboard operations and easy for the user to traverse, enter data and or self correct with in the confines of the range of the text fields for a given character set.

Once the student is satisfied with the characters that have been keyed into the text-input fields he or she can then manually submit the characters to be automatically scanned by the error identifier system.

The error identifier system will give the user an interactive change in media for each character that does not correspond to the predefined character set and or sequentially match up to the predefined character set. Further the system will give an interactive change in media based on 3 Boolean values that correspond to, as to whether, all the characters were entered correctly, one or more mistakes and one or more text-input fields do not contain a character.

In the case of the working interactive spelling primer prototype that I developed, when a user enters a wrong character(s) a red indicator becomes visible behind the character(s) in the text-input field(s) and an animated butterfly gives a negative lip-synced response. When a user enters no character(s) in a text-input field(s) it responds as it would to an incorrect character (however, it could give a completely different response, as it is a unique Boolean value). When a user is absolutely correct in his or her response an animated butterfly gives a positive response and the program goes on to the next character set or chapter with entertaining animation that relates to the character sets and static text.

Further the software is capable of scoring based on incorrect or correct responses. I want to stress that, this invention claim is not for the interactive spelling primer as a whole, but for the software components, that it contains, that perform the mechanics of individual error indicating and ease of use character processing within the confines of predefined text-input field(s). This process will work with math and or other educational curriculum as well.

It should also be noted that, interactive media changes used as examples here can be replaced by any numerous different kinds of interactive media changes. It is the software-based mechanics, which cause the interactive change in media, which is relevant to the exclusive right claimed.

Although I believe education is the primary market for this invention . . . it should, by no means, be limited to the education market.

### CONCLUSION

Although the present invention has been described in connection with the preferred form of practicing it, it will be understood by those of ordinary skill in the art that many modifications can be made thereto within the scope of the claims that follow. Accordingly, it is not intended that the scope of the invention in any way be limited by the above description, but that it be determined entirely by reference to the claims that follow.

The invention in which an exclusive right is claimed is defined by the following:
1. If the current focus is not on the last data entry point and or text input field, sets focus to the incremental consecutive data entry point and or text input field after a user inputs data and or character(s) into the previous data entry point and or text input field with a keyboard or other such device that contains keys, or when the user inputs the right arrow key or the space key with a keyboard or other such device that contains keys (Note: the term “right arrow” and “space” are used for illustrative purposes only);
if the current focus is not on the first data entry point and or text input field, sets focus to the next diminutive consecutive data entry point and or text input field upon the detection of a user's interaction with the left arrow key with a keyboard or other such device that contains keys (Note: the term “left arrow” is used for illustrative purposes only);
Upon a manual mouse click into a data entry point and or text input field, the program will automatically be able to detect the correct consecutive value of the other data entry point(s) and or text input field(s), in relation to the data entry point and or text input field where the mouse was clicked;
If the program detects that the key dose not has a character value or point of focus value in relation to the data entry point(s) and or text input field(s) in the program, then, the program automatically disengages from the routine and does not perform the task of changing the focus to the next incremental data entry point and or text input field or to the next diminutive data entry point and or text input field.
2. Upon the detection of a user's interaction with the backspace key with a keyboard or other such device that contains keys automatically scans the data entry point and or text input field that has the current focus and detects whether or not the data entry point and or text input field contains a character and or data;
If the data entry point and or text input field that has the current focus does not contain a character and or data the program automatically changes the focus to the next diminutive data entry point and or text input field;
If the data entry point and or text input field that has the current focus does contain a character and or data, the focus remains on the current data entry point and or current text input field that has focus so that the character and or data contained in the data entry point and or text input field can be logically deleted (note: the term “backspace” is used for illustrative purposes only);
3. Enabling the user to activate the method by pressing the enter key or clicking an appropriate button and or mouse listener object (note: the term “Enter key” is used for illustrative purposes);
automatically scanning character(s) and or data entered by the user; automatically indicating any data entry point(s) and or text input field(s) that contain characters and or data that does not correspond to and or corresponds to the predefined character set and or data entry point(s) and or text input field(s) with a value of null, with the use of an interactive change in media;
calculates the number of times that the data entry point(s) and or text input field(s) contains data and or character(s) that do not correspond and or corresponds to the predefined character set(s) and gives an interactive change(s) of media based on three Boolean values (data and or character(s) correspond to pre-defined data set, data and or one or more character(s) do not correspond to pre-defined data set and or one or more data entry point(s) and or text input field(s) are equal to null);
Upon scanning the data entry point(s) and or text input field(s), the program will automatically count the number of times that data and or Character(s) do not correspond to the predetermined data set(s) and the number of times data entry point(s) and or text input field(s) are equal to null;
Upon scanning the data entry point(s) and or text input field(s), If the number of data entry point(s) and or text input field(s) having no characters is NOT less then one (1), the program will automatically command the media, corresponding to the Boolean value, that equals “data entry point(s) and or text input field(s) is equal to null”, to load;
Upon scanning the data entry point(s) and or text input field(s), if all characters and or data, upon scanning, correspond to the predefined data set(s) the program will Automatically command the media, corresponding to the Boolean value, that is equal to “all char and or data corresponds to the pre determined data and or character set”, to load.

### Information on Prior Dropped CDs

With the first non-provisional application, filed on Oct. 6, 2004, I included 2 CDs that are exact copies of the prototype of the Constant Range of Size Data Entry and Character Error Indication System. Entitled the “World of Spelling”.

When I started developing this application in October of 2002 in Eugene Oreg. I was not trying to make a patent oriented product. I was just trying to make a demo for children's learning. It was not until after I finished the “World of Spelling” that I realized that I might have an exclusive intellectual property in terms of software and programming mechanics.

If the examiners have trouble understanding any of the claims they should reference the “world of Spelling CD” That was sent in 2004.

Although I have broadened the legal language in the specification sheets . . . . I have made no changes to the “world of Spelling” program in terms of the software mechanics.

The only reason I dropped these CDs was because USPTO said they were not a legal form of evidence in terms of a patent application.

1. If the current focus is not on the last data entry point and or text input field, sets focus to the incremental consecutive data entry point and or text input field after a user inputs data and or character(s) into the previous data entry point and or text input field with a keyboard or other such device that contains keys, or when the user inputs the right arrow key or the space key with a keyboard or other such device that contains keys Note: the term “right arrow” and “space” are used for illustrative purposes only);
if the current focus is not on the first data entry point and or text input field, sets focus to the next diminutive consecutive data entry point and or text input field upon the detection of a user's interaction with the left arrow key with a keyboard or other such device that contains keys (Note: the term “left arrow” is used for illustrative purposes only);
Upon a manual mouse click into a data entry point and or text input field the program will automatically be able to detect the correct consecutive value of the other data entry point(s) and or text input field(s), in relation to the data entry point and or text input field where the mouse was clicked;
If the program detects that the key dose not has a character value or point of focus value in relation to the data entry point(s) and or text input field(s) in the program, then, the program automatically disengages from the routine and does not perform the task of changing the focus to the next incremental data entry point and or text input field or to the next diminutive data entry point and or text input field.

2. Upon the detection of a user's interaction with the backspace key with a keyboard or other such device that contains keys automatically scans the data entry point and or text input field that has the current focus and detects whether or not the data entry point and or text input field contains a character and or data;
If the data entry point and or text input field that has the current focus does not contain a character and or data the program automatically changes the focus to the next diminutive data entry point and or text input field;
If the data entry point and or text input field that has the current focus does contain a character and or data, the focus remains on the current data entry point and or current text input field that has focus so that the character and or data contained in the data entry point and or text input field can be logically deleted (note: the term “backspace” is used for illustrative purposes only);

3. Enabling the user to activate the method by pressing the enter key or clicking an appropriate button and or mouse listener object (note: the term “Enter key” is used for illustrative purposes):
automatically scanning character(s) and or data entered by the user:
automatically indicating any data entry point(s) and or text input field(s) that contain characters and or data that does not correspond to and or corresponds to the predefined character set and or data entry point(s) and or text input field(s) with a value of null, with the use of an interactive change in media;
calculates the number of times that the data entry point(s) and or text input field(s) contains data and or character(s) that do not correspond and or corresponds to the predefined character set(s) and gives an interactive change(s) of media based on three Boolean values (data and or character(s) correspond to pre-defined data set, data and or one or more character(s) do not correspond to pre-defined data set and or one or more data entry point(s) and or text input field(s) are equal to null);
Upon scanning the data entry point(s) and or text input field(s), the program will automatically count the number of times that data and or Character(s) do not correspond to the predetermined data set(s) and the number of times data entry point(s) and or text input field(s) are equal to null;
Upon scanning the data entry point(s) and or text input field(s), If the number of data entry point(s) and or text input field(s) having no characters is NOT less then one (1), the program will automatically command the media, corresponding to the Boolean value, that equals “data entry point(s) and or text input field(s) is equal to null”, to load, Upon scanning the data entry point(s) and or text input field(s), if all characters and or data, upon scanning, correspond to the predefined data set(s) the program will Automatically command the media, corresponding to the Boolean value, that is equal to “all char and or data corresponds to the pre determined data and or character set”, to load.

4-11. (canceled)
